(19) United States
(12) Patent Application Publication
(10) Pub. No.: US 2008/0024118 A1
(43) Pub. Date: Jan. 31, 2008

(54) Magneto-Resistive Sensor for High Sensitivity Depth Probing

(75) Inventors: Josephus Arnoldus Henricus Maria Kahlman, Eindhoven (NL); Menno Willem Jose Prins, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,168

(22) PCT Filed: May 17, 2005
(86) PCT No.: PCT/IB05/51588

§ 371 Date: Nov. 16, 2006

(30) Foreign Application Priority Data
May 24, 2004 (EP) 04102257.5

(51) Int. Cl. G01N 27/74; G01N 27/72

(52) U.S. Cl. 324/204; 324/225

(57) ABSTRACT

A sensor device (40) and a method for detection of the presence of at least one magnetic particle (46) are described. More particularly, a sensor device (40) comprising at least one magnetic field generating means (41) and at least one magnetic sensor element (42) is provided. The sensor device (40) furthermore comprises an exclusion zone (44), such as a spacer (44b) at the sensor surface (45), for excluding magnetic particles or beads (46) in the relative vicinity of the magnetic sensor element (42). The sensor device (40) according to the invention shows high depth or bulk sensitivity.

The present invention relates to a sensor device and a method for detection of magnetic particles in a fluid or in a solid environment. The device and method can be used for the detection of target molecules, such as e.g. tumor markers and pathogen-derived material in the pmol/L range and lower, in a sample fluid. The sensor according to the invention can furthermore be used for a molecular assay, but also for the detection of components or of processes in micro-organisms, cells, cell fragments, tissue, etc.

The challenge of biosensing is to detect small concentrations of specific target material in a complex mixture with high concentrations of e.g. mmol/L of background material (e.g. proteins such as albumin).

Biochips, also called biosensor chips, biological microchips, gene-chips or DNA chips, consist in their simplest form of a substrate on which a large number of different probe molecules are attached on well defined regions on the chip, to which probe molecules target molecules or molecule fragments that are to be analyzed can bind if they are well matched. For example, a fragment of a DNA molecule binds to one unique complementary DNA (c-DNA) molecular fragment. The occurrence of a binding reaction can be detected, e.g. by using labels, such as e.g. fluorescent markers, that are coupled to the molecules to be analyzed. This provides the ability to analyze small amounts of a large number of different target molecules or molecular fragments in parallel, in a short time. One biochip can hold assays for 1000 or more different molecular fragments. It is expected that the usefulness of information that can become available from the use of biochips will increase rapidly during the coming decade, as a result of projects such as the Human Genome Project, and follow-up studies on the functions of genes and proteins.

Magneto-resistive biochips are one type of biochips which have promising properties for bio-molecular diagnostics in terms of sensitivity, specificity, integration, ease of use and costs. Examples of such biosensors are described before, a.o. in WO 2003/054566, WO 2003/054523 and Rife et al., Sens. Act. A vol. 107, p. 209 (2003). A disadvantage of these biosensors, however, is that they have a limited depth sensitivity, in the order of a few micrometer or less. This limited depth sensitivity is well suited to detect magnetic nanoparticles that are located close to the sensor on the surface of the chip. However, the depth sensitivity is insufficient for applications wherein the magnetic labels are situated at larger distances, as is the case in high-surface-area biosensors (e.g. in lateral flow devices or flow-through chips) and in systems with receptacles, as in WO 00/26669 (see further).

The most well-known lateral flow biosensor, also called immuno-chromatography or strip test, is the urine dipstick for pregnancy testing. In this biosensor, the test fluid is applied to a porous paper strip, which, in general, is nitro-cellulose, wherein the fluid travels by passive capillary forces. A reagent, such as for example antibodies with optical labels, dissolves in the fluid and subsequently binds the target molecules, which in the case of the urine dipstick for pregnancy testing, is the pregnancy hormone hCG. Thereafter, the fluid passes the detection region, this is an area where second capture antibodies are bound to the porous medium. There, the bound complexes, i.e. the target bound to the first labelled antibodies, are captured on the solid surface and form a sandwich structure, i.e. a surface-antibody-target-antibody-label. Lateral flow devices generally use optical detection, e.g. optical reflection, which e.g. uses latex particles, 20-nm gold labels or fluorescence.

Two examples of flow-through biochips are from Metrigenix (microporous silicon) and Pamgene (nanoporous aluminum oxide). In both cases, the porous high-surface area elements of the devices are tens to hundreds of micrometers thick and the fluid flow occurs perpendicular to the chip body. In both cases the detection is performed optically (fluorescence, chemiluminescence).

As described above, lateral-flow and flow-through biosensors generally use optical detection. These methods have problems such as interfering substances, e.g. other fluorescent species or auto-fluorescence, specular reflection, optical absorption, optical scattering, quenching of signal in fluorescence-based tests, or the requirement of an additional washing step and additional reagents, as is for example required for chemiluminescence. As a result, these methods are not suited for high-sensitivity measurements in high-surface-area biosensors.

WO 00/26669 relates to the detection of biochemical substances in a receptacle, using a giant magnetoresistive effect. The document provides a system for making a biochemical assay of each of a plurality of provided specimens which includes a plurality of receptacles, a sensor for providing a resistance, a mechanism, and a controller. Each receptacle comprises a specimen and includes a surface for binding a paramagnetic particle (PMP) to the surface. When biased by a magnetic field, the presence of a PMP affects the resistance of the sensor in accordance with a giant magnetoresistive effect. The mechanism positions each respective surface in working proximity to the sensor for providing a respective resistance. The controller controls the mechanism for recording indicia of each respective resistance.

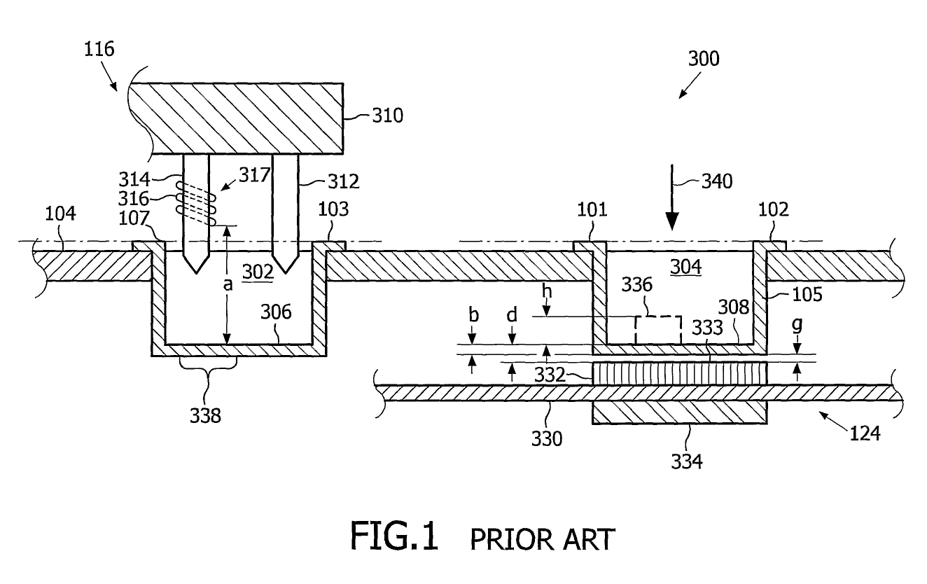

FIG. 1 illustrates a cross section of a portion of the specimen dispenser/decanter 116 of the system 300 and the PMP detector 124 according to WO 00/26669. In FIG. 1, arm 310 of specimen dispenser/decanter 116 provides pipettes 312 and 314 into receptacle 107 of specimen carrier 103. Pipette 314 includes coil 316 that establishes a magnetic field within pipette 314 for PMP removal. Receptacle 107 contains fluid specimen 302 in contact with its interior bottom surface 306. Pipette 314 includes magnetic trap 317 having a magnetic field primarily within pipette 314. By keeping magnetic flux from magnetic trap 317 away from bottom surface 306, especially region 338, interference with PMP movement and binding is reduced. Region 338 corresponds to a sensitivity region 336 of a sensor placed under receptacle 103 as shown under receptacle 102. Sensitivity region 336 has planar dimensions on surface 308 of about 1 millimeter by about 1 millimeter and extends into specimen 304 a distance ‘h’ of about 10 micron.

Specimen carrier 102 is located in specimen tray 104. Specimen tray 104 facilitates mechanical protection, identification, preparation, storage, handling, and disposal of multiple specimen carriers 102 and 103. The strip portion of each facilitates vertical insertion and removal from specimen tray 104 and facilitates location of the base 105 of each receptacle 101 a predetermined distance relative to specimen tray 104. Base 105 may have a thickness ‘b’ of between 0.5 mm and 1 mm. Specimen carrier 102 and tray 104 may include mechanical or electronic features that identify each specimen, for example, orientation limitations and/or machine readable indicia of patient identifier, receptacle serial number, date, test sequence number, etc. Tray 104 provides convenient fluid access to the top of specimen carriers 102 and 103 and provides convenient electromagnetic access through the bottom of specimen carriers 102 and 103. Specimen tray 104 is held in position against a circuit board 330 of PMP detector 124 by a pressurized atmospheric force schematically represented by arrow 340. Specimen carrier 102 includes receptacle 101 that contains fluid specimen 304 in contact with its interior bottom surface 308. Sensor 332 is fixed to the top surface of circuit board 330, while magnet 334 is fixed to the bottom surface of circuit board 330. Circuit board 330 is held immobile with respect to the vertical movement of specimen tray 104, specimen carrier 102, and receptacle 101. Force 340 operates against specimen 304 and receptacle 101 to locate surface 308 a predetermined distance ‘d’ from the top surface of sensor 332. A sensor 332, according to various aspects of WO 00/26669 exhibits a region of sensitivity to the presence of PMPs defined herein as the distance at which the probability of detection of a single PMP is 50%. For example, sensor 332 is sensitive to the presence of one or more PMPs that may exist within sensitivity region 336. Sensitivity region 336 extends from sensor 332 across a gap (if any) between sensor 332 and receptacle 101, through the bottom of receptacle 101 and above surface 308. In one implementation, the distance between the interior surface 308 and the top 333 of a sensor 332 (illustrated as the distance ‘g’) in region 336 is established and maintained during detection in the range 0 to about 50 microns. The sensor 332 is designed and operated to exhibit a height ‘h’ of region 336 above surface 308 during detection in the range of 2 to 20 μm and preferably about 10 μm.

A disadvantage of the above described system is that the system comprises large distances h and g between 0 and tens of μm and a large bottom thickness b of between 0.5 mm and 1 mm. Furthermore, magnetic fields are applied by a magnet fixed to the bottom of the circuit board and a coil that is preferably formed as a spiral under all GMR sensors. It may hence be concluded that, in that way, out-of-plane magnetic fields are applied. Moreover, measurements are performed at low frequencies of between 100 Hz and 300 Hz. Because of these large distances, the out-of-plane fields and the low measurement frequencies, the system of WO 00/26669 will show a bad or low detection sensitivity.

It is an object of the present invention to provide a sensor which is able to probe deeply into a material, i.e. in the range of 1 micrometer to 300 micrometer, suitable for detecting magnetic particles and which nevertheless is inexpensive. Hence, the sensor is suitable for chemical or biological molecular diagnostics or for biological sample analysis with high sensitivity (e.g. proteins with a concentration in the range of pmol/L and lower). The aim for high biological sensitivity is related to the aim for high magnetic-label-detection sensitivity.

The above objective is accomplished by a method and device according to the present invention. The invention relates to a sensor device comprising an exclusion region at the sensor surface to avoid the presence of magnetic beads in relative vicinity to this sensor surface. The sensor device shows high depth or bulk sensitivity. The sensor device according to the invention enables the detection of magnetic labels or particles with a signal-to-noise ratio which is higher than for prior art sensor devices.

In a first aspect of the invention, a sensor device is provided for detection of magnetic particles in a sample fluid, i.e. in a liquid as well as in a gas, and for the detection of magnetic particles in a solid environment. The device comprises:

at least one magnetic or electric field generating means and

at least one magnetic sensor element, the at least one magnetic sensor element comprising a sensitive layer,

and wherein the sensor device is provided with an exclusion zone between the sensitive layer of the at least one magnetic sensor element and the magnetic particles for excluding presence of magnetic particles in the vicinity of the magnetic sensor element, the exclusion zone having a thickness of between 1 and 300 μm, preferably between 1 and 200 μm and more preferably between 1 and 100 μm.

In one embodiment, the exclusion zone may be formed as a layer of the sensor chip, i.e. as a ‘cover layer’ in between the sensor element and the surface of the sensor chip, or, in another embodiment, as a separate spacer layer which is fixed to the surface of the sensor chip, e.g. glued.

In other embodiments of the invention, the functionality of an exclusion zone may be implemented by having a zone where magnetic particles or beads do not stick, where magnetic particles or beads can be removed, or where magnetic particles or beads cannot enter due to mechanical forces.

An advantage of the sensor according to the invention is that it shows high depth sensitivity by excluding target molecules, or other substances to be detected, from the vicinity of the sensor element.

The sensor device may comprise one magnetic or electric field generating means and one magnetic sensor element positioned adjacent each other. The magnetic sensor element may, for example, be a magneto-resistive sensor element such as e.g. a GMR, TMR or AMR sensor element. The magnetic or electric field generating means may have a first width and the magnetic sensor element may have a second width. The first and second width may be such that the second width to first width ratio is smaller than 1. By changing the magnetic sensor element width to current wire width ratio, the resulting sensitivity of the sensor device may be determined according sensitivity required for particular applications.

In another embodiment of the invention, the magnetic or electric field generator means may be positioned at each side of the magnetic sensor element at the same z position.

In a further embodiment of the invention, a plurality of magnetic or electric field generator means and magnetic sensor elements, such as e.g. a magneto-resistive sensor element, may be positioned alternately adjacent to each other. By applying a plurality of magnetic or electric field generator means, e.g. current wires, and magnetic sensor elements e.g. GMR sensor elements, the depth probing range of the sensor may be further increased.

In one embodiment, the sensor device may furthermore comprise at least one coupling means in between the spacer and the top surface of the sensor device. The coupling means may be connected to the top surface of the sensor chip via a flip-chip technique. This coupling means may serve for galvanic, magnetic, electrical and/or RF coupling to external connections.

In still another embodiment, the sensor device may furthermore comprise:

at least one porous medium, each porous medium comprising a reagent or a biological capture surface, the at least one porous medium being integrated with said exclusion zone of the sensor device and

a sample fluid supply for supplying the sample fluid to the at least one porous medium.

The sensor device may comprise a first porous medium comprising a first reagent or capture layer and a second porous medium comprising a second reagent or capture layer, the first and second reagent being different from each other. In that way, the sensor according to the invention may be used to determine or detect different target molecules at the same time.

The at least one magnetic field generating means may be an on-chip magnetic field generating means, e.g. a current wire or may be an external coil.

The present invention furthermore provides an array of sensor devices according to the invention and the use of the sensor device according to the invention in biological or chemical molecular diagnostics and in biological sample analysis.

In a further aspect of the invention, a method for the detection of the presence of at least one magnetic particle is provided. The method comprises:

providing a sample fluid with magnetic particles or beads,

thereafter providing a sensor device in contact with the sample fluid, the sensor device comprising:

at least one magnetic or electric field generating means, and

at least one magnetic sensor element, the at least one magnetic sensor element having a top surface,

applying an electric or magnetic field,

and wherein the presence of magnetic particles in the direct vicinity of the at least one magnetic sensor element is avoided by providing the sensor device with an exclusion zone having a thickness of between 1 and 300 μm, preferably 1 and 200 μm and more preferably 1 and 100 μm. Providing the exclusion zone may be performed by providing a spacer on top of the sensor surface.

The method according to the invention shows a higher depth sensitivity than prior art methods.

The method of the present invention may be used in biological or chemical molecular diagnostics and in biological sample analysis.

Although there has been constant improvement, change and evolution of devices in this field, the present concepts are believed to represent substantial new and novel improvements, including departures from prior practices, resulting in the provision of more efficient and reliable devices of this nature.

These and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a cross section of a portion of a specimen dispenser/decanter and a PMP detector according to the prior art.

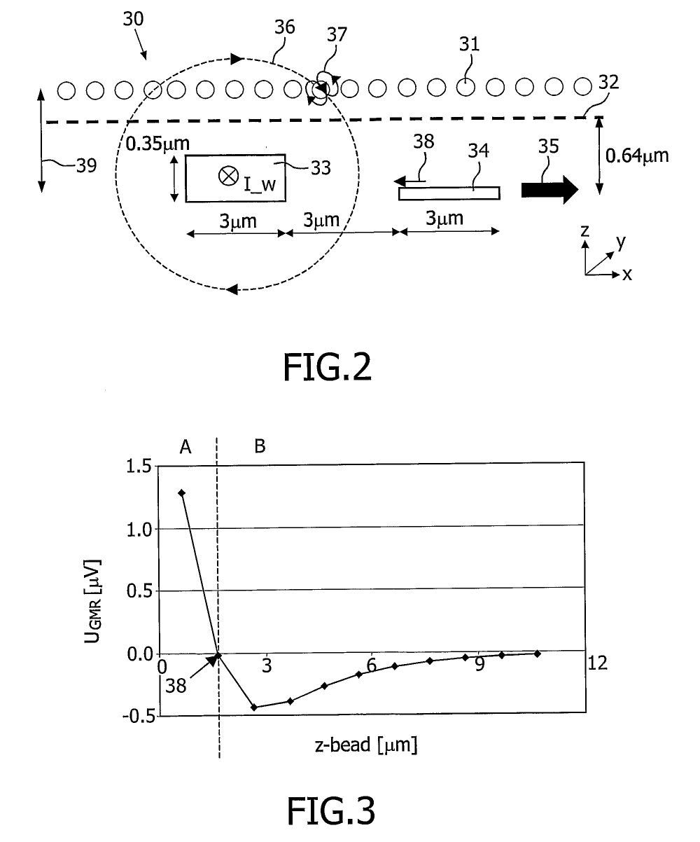

FIG. 2 illustrates a magneto-resistive sensor.

FIG. 3 graphically illustrates the GMR voltage as a function of the distance of a sheet of magnetic particles with a particle density of 1 bead/μm² to the sensor surface for the magneto-resistive sensor of FIG. 2.

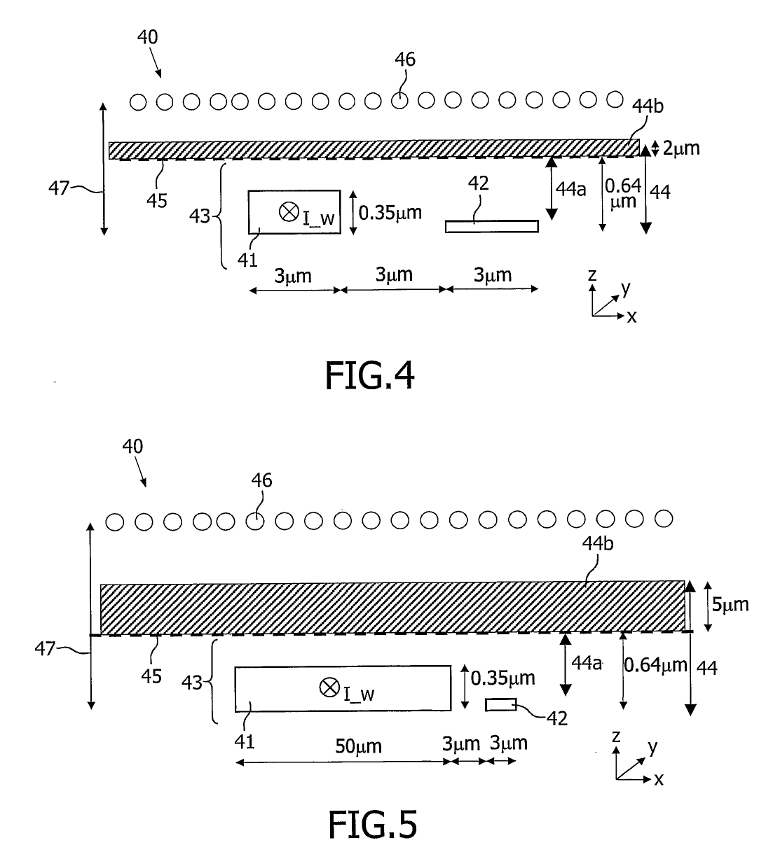

FIG. 4 illustrates a magneto-resistive sensor configuration according to one embodiment of the present invention.

FIG. 5 illustrates a magneto-resistive sensor configuration according to a second embodiment of the present invention.

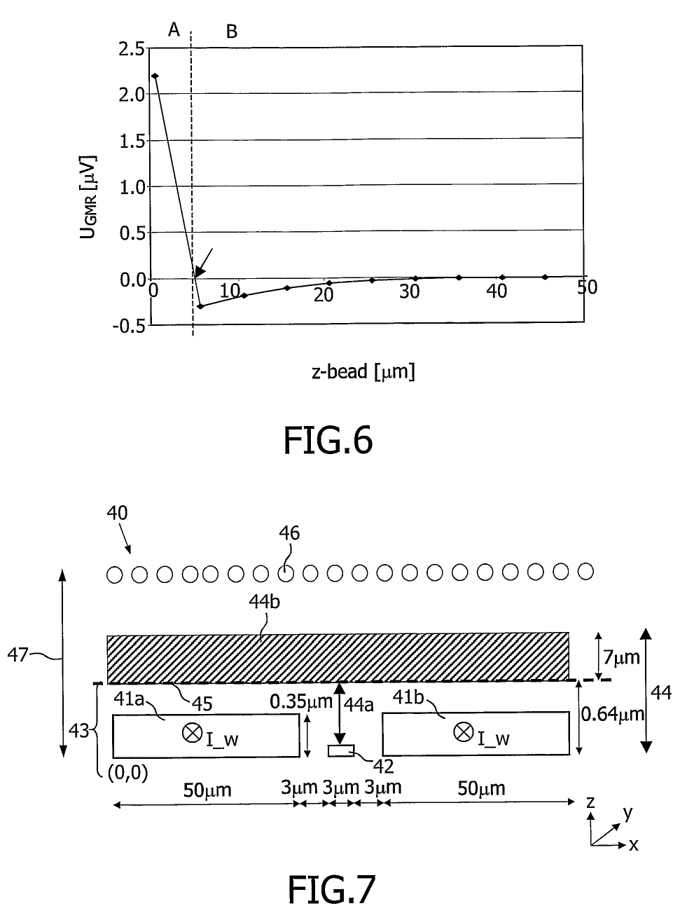

FIG. 6 graphically shows the GMR voltage as a function of the distance of a magnetic particle to the sensor surface for the magneto-resistive sensor of FIG. 5.

FIG. 7 illustrates a magneto-resistive sensor configuration according to a third embodiment of the present invention.

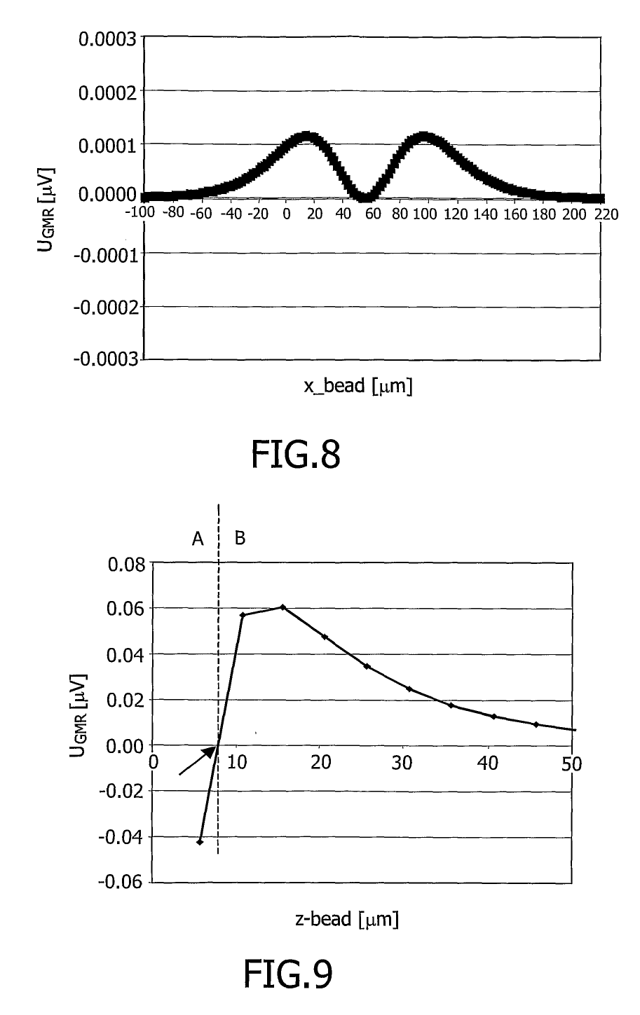

FIG. 8 graphically shows the GMR voltage as a function of the position of the beads for the magneto-resistive sensor of FIG. 7.

FIG. 9 graphically shows the GMR voltage as a function of the distance of magnetic particles to the sensor surface for the magneto-resistive sensor of FIG. 7.

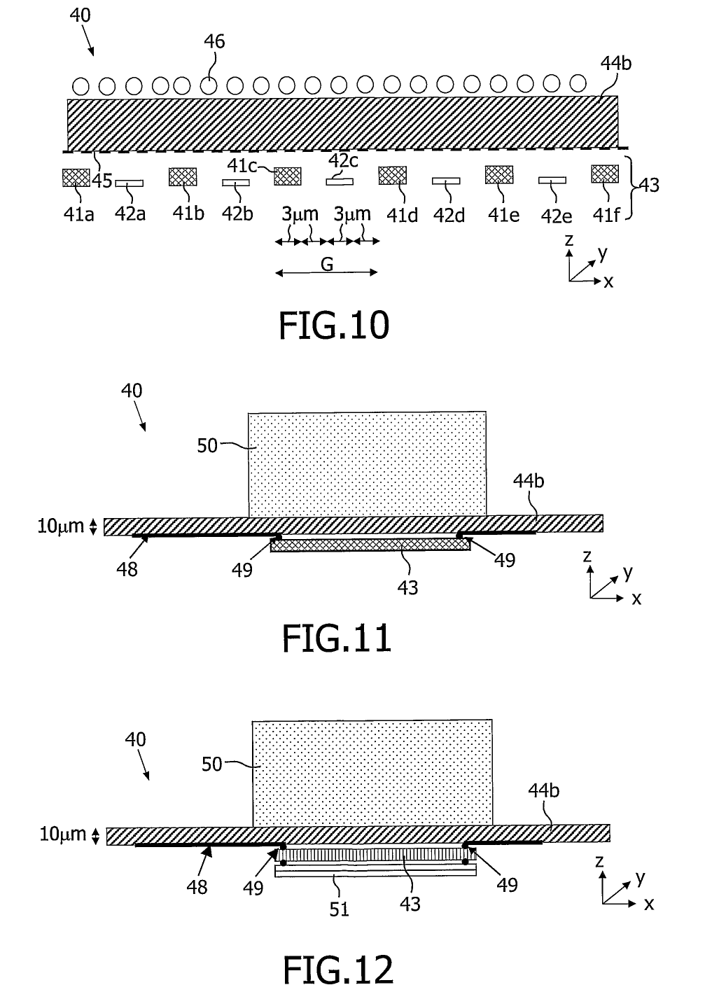

FIG. 10 illustrates a magneto-resistive sensor configuration according to a fourth embodiment of the present invention.

FIG. 11 and 12 illustrate magneto-resistive sensor configurations according to a fifth embodiment of the present invention.

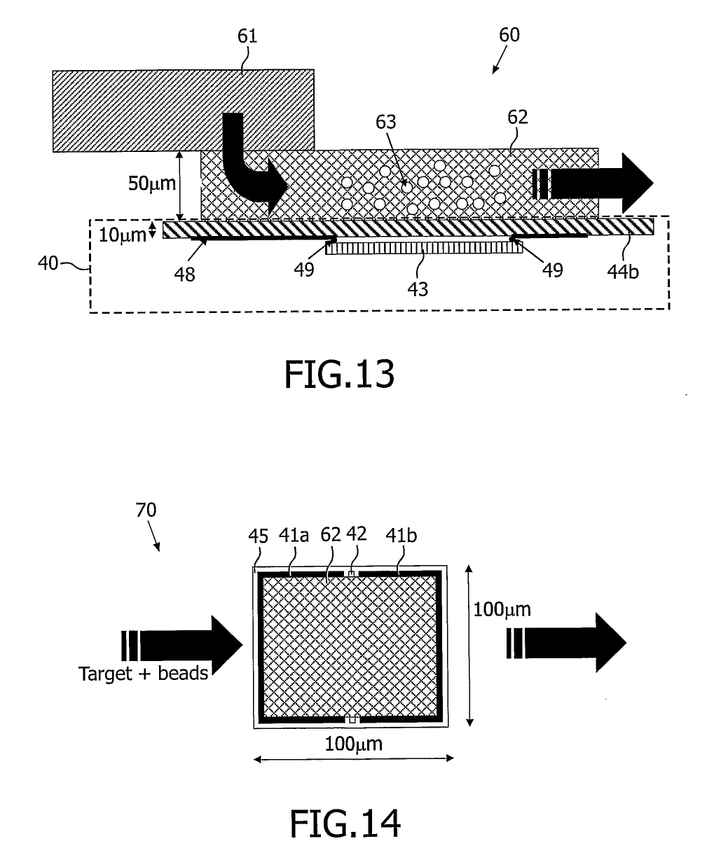

FIGS. 13 to 16 illustrate magneto-resistive sensor configurations according to a sixth embodiment of the present invention.

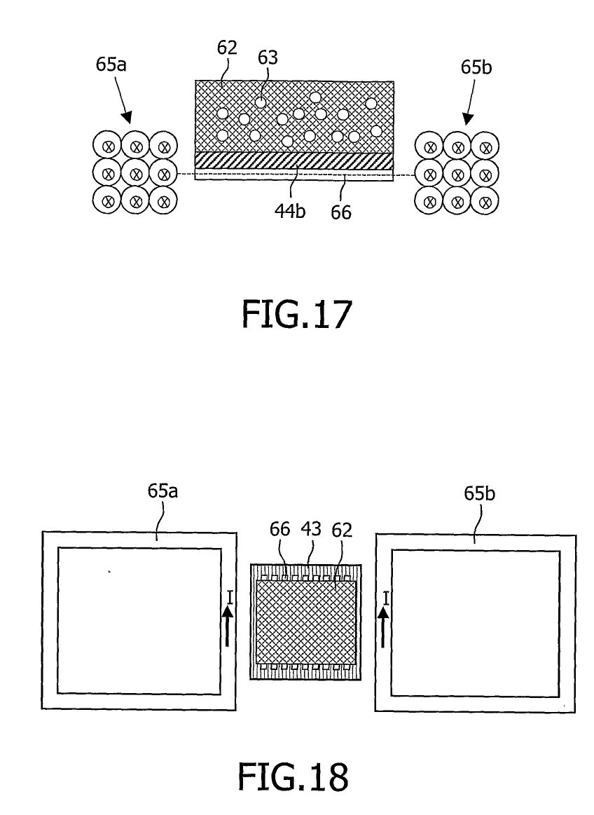

FIG. 17 and 18 illustrate magneto-resistive sensor configurations according to a seventh embodiment of the present invention.

In the different figures, the same reference signs refer to the same or analogous elements.

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

The present invention provides an inexpensive and robust magnetic sensor device, e.g. a magneto-resistive sensor device, that is able to probe deeply into a material (in the range of 1 micrometer to a few millimeter) with a high detection sensitivity.

The magnetic sensor may be a biosensor for detecting analytes in a sample fluid, but the invention also applies for other chemical, biochemical or biological sensors. Examples may e.g. be sensors with biological cells or tissue on a surface, which require a high degree of depth sensitivity because biological cells have a diameter between several micrometers up to a millimeter.

As already discussed above, most of the prior art magneto-resistive biosensors do not have sufficient depth sensitivity for applications in high-surface-area biosensors such as lateral flow devices or flow-through chips. This is because these magneto-resistive biochips 30 are most sensitive to beads or magnetic nanoparticles 31 close to the surface 32 (see FIG. 3), as magnetic field decreases with distance. Furthermore, the surface response signal can disturb (reduce) the bulk signal. This phenomenon will be illustrated by means of the excitation method on a biosensor as illustrated in FIG. 2, but is, however, applicable to all magnetic field sensors having an in-plane sensitivity. The integrated excitation method can be considered as a three-step process. A current in a current-wire 33 generates a magnetic field 36, which magnetises, for example, superparamagnetic beads 31, which generate an in-plane magnetic field component 38 in the active layer of the GMR sensor element 34. By calculating the magnetic field components in each successive process step, the GMR sensor signal is determined.

In FIG. 2, a co-ordinate system is introduced to indicate that, if the sensor device 30 is positioned in the xy plane, the GMR sensor element 34 detects essentially the x-component of a magnetic field, i.e. the x-direction is the sensitive direction of the sensor element 34. The sensitive x-direction of the GMR sensor element 34 according to the present invention is indicated by the arrow 35 in FIG. 2. Because the sensor element 34 is hardly sensitive in the z-direction or direction perpendicular to the plane of the sensor device 30, in the drawing the vertical direction, a magnetic field 36, caused by a current flowing through the current wire 33, is only partially detected by the sensor element 34. When a magnetic nano-particle or bead 31 is in the neighborhood of the current wire 33, it develops a magnetic moment indicated by the field lines 37 in FIG. 2. The magnetic moment then generates dipolar stray fields, which have in-plane magnetic field components 38 at the location of the sensor element 34. Thus, the nano-particle 31 deflects the magnetic field 36 in the sensitive x-direction of the sensor element 34 indicated by arrow 35 (FIG. 2). The x-component of the magnetic field which is in the sensitive x-direction of the sensor element 34, is sensed by the sensor element 34 and depends on the number of magnetic nano-particles 31 and the current flowing through the current wire 33.

Hereinafter, the factors that determine the signal and the noise will be discussed. The signal is proportional with the magnetic moment of the magnetic particles 31 (and hence depends on particle size, magnetic susceptibility, applied magnetic field), the concentration or number of magnetic particles 31, the sensitivity of the sensor 30 (change of resistance per unit magnetic field) and the sense-current through the sensor 30. In the case of a white noise spectrum, the noise of the sensor 30 is proportional to the zero field GMR resistance, the detection bandwidth (which is inversely proportional to the averaging time) and the temperature.

For the sake of simplicity and with the goal to compare several embodiments of the invention, the following values will be assumed:

Particles with a diameter of 130 nm and with magnetic susceptibility per bead χ=7.6 10⁻²¹ m³,

Length of GMR sensor element equals 100 μm (in the y-direction), which is much larger than the 3 μm width of the GMR sensor, the sensor element having a length/width ratio of at least 10,

The GMR sensor element 34 consists of a stack of several thin films. In the present invention, the magnetically sensitive layer is located at z=40 nm.

Sensor sensitivity S_{GMR}=0.005 Ωm/A, which is the resistance change due to a magnetic field strength, expressed in Ω per A/m=Ωm/A,

Zero-field resistance of the GMR sensor element equals 560 Ω,

Sense current in the GMR sensor equals 1 mA,

Current through the field-generating wire I_{wire} equals 10 mA,

Due to the high excitation frequency, the 1/f noise of the GMR sensor element 34 is negligible so that the noise is given by the thermal resistance noise of the GMR sensor element. An averaging time of 0.5 second is assumed. Therefore, using the sensor resistance of 560 Ω and room temperature, a noise level of (4k_{b}TRB)^{1/2}=3 nV is assumed.

Volume density of beads equals 1 bead/μm³,

It has to be noticed that these values are only meant as an example and hence, are not limiting for the invention.

Using the above values, the sensor signal will be calculated for the embodiments according to the invention (see further). The calculation may be performed as follows. A first step is to calculate the magnetic field generated by the field generating means. The perturbation of the magnetic fields by the relative magnetic permeability of the materials of the GMR sensor may be neglected, so μᵣ₌₁ fill is assumed. A second step is to determine the magnetic dipole moment of a row of particles or beads 31 along the y-axis at position (x,z) by using the magnetic susceptibility per bead 31. The length of the sensor element 34 is much larger than its width; therefore the perturbations of the field at the end of the sensor strip may be neglected. In a third step the GMR signal resulting from the average in-plane magnetic field strength in the sensitive layer of the GMR sensor element 34 may be calculated. In a fourth step, an integration along the x-axis is performed. As such, the signal originating from a xy-sheet of particles 31 as a function of the z-position is obtained. In a fifth step, an integration or summation along the z-axis is performed. As such, the bulk signal U_{GMR,bulk} originating from a volume of particles 31 is obtained.

By using the calculated noise and calculated signal, the volume density of nanoparticles 31 that would correspond to a signal-to-noise ratio (SNR) equal to one can be estimated. For simplicity, the concentration corresponding to SNR=1 is called the detection limit. This is a rather arbitrarily chosen level, because it can for example easily be improved by increasing the sense current, the applied magnetic field, or the size or the magnetic moment of the magnetic nanoparticle. Nevertheless, the calculated value is used to compare the performance of the sensors according to the different embodiments of the present invention.

It has to be noted that the biological detection limit is directly related to the label-detection-limit of the sensor, when additional factors are taken into account such as the concentration of capture molecules, the pore size in case of a high-surface-area material, the association and dissociation rates of the binding and unbinding, flow parameters (mixing, shear flow), incubation time, stringency steps, etc.

Using the above parameters, the GMR voltage equals U_{GMR,bulk}=−0.33 μV for the sensor illustrated in FIG. 2. The volume detection limit, defined as the volume density for a SNR=1, then equals d_{bulk}=6.5 10⁻³ beads/)μm³.

It has to be noted that the maximum allowable current density in the current wire 33 is limited by the electro-migration, which equals 1 mA per 100 nm×100 nm cross sectional area as a safe value for long-term operation. For example, in the case of FIG. 2 where the wire width equals 3 μm and the wire thickness equals 0.35 μm, the long-term electro-migration limit gives a maximum current in the wire 33 of 105 mA. This means that the detection limit can be a factor of 11 lower than estimated above. It is to be noted that the current can be further increased, and thus the detection limit decreased, when long-term operation is not required, as is the case for a disposable biosensor. It has to be noted that resistive electrical currents can cause power dissipation and a rise of the temperature. Temperature changes may need to be limited for certain assays and certain materials, e.g. to avoid de-naturing of proteins. This can put a restriction on the allowed current magnitudes, the length of the averaging times and the time interval between measurements during the assay. At the end-point of the assay the biological materials can be allowed to de-nature, which relieves current limitations and will allow a very sensitive end-point measurement of magnetic labels.

FIG. 3 shows the GMR signal or GMR voltage, at 1 bead/μm³ volume density, as a function of the z-position of xy-sheets of uniformly distributed superparamagnetic beads, i.e. as a function of the distance between the sheet and the surface of the sensor element 34, in case of the sensor device 30 of FIG. 2. The sheets comprise nanoparticles 31 at a density of 1 bead/μm², subsequent sheets are spaced 1 μm from one another (not shown in the figure). In FIG. 3, the zero crossing occurs at 1.65 μm (indicated by arrow C). This figure furthermore shows that the surface signal, which originates from beads or nanoparticles 31 close to the surface 32 (indicated by region A in FIG. 3) of the sensor device 30 (z (indicated by arrow)≦1.65 μm), is positive while the response from beads 31 in the bulk (indicated by region B in FIG. 3) (z≧1.65 μm) is negative valued. Because the sensor response to a volume of beads 31, which is called depth sensitivity, is indicative to the area under the curve, the (positive) surface signal will decrease the depth sensitivity. This is a first reason why the effect of beads 31 close to the sensor surface 32 should be removed. Furthermore the surface signal (region A) is much larger than the depth- or bulk-signal (region B), which is a second reason to remove the effect of beads 31 close to the surface 32. Furthermore, the depth-probing range of the sensor as illustrated in FIG. 2 is limited to z≦10 μm, which is too small in practical bulk measurements.

Therefore, the present invention provides a magnetic sensor device 40 for detecting analytes in a fluid sample or complex mixture such as e.g. blood, tissue, cell culture, and a detection method with optimized bulk or depth sensitivity by excluding magnetic beads in relative vicinity to the surface. The idea of the present invention is to exclude beads or magnetic particles from the sensor surface. By doing so, the beads or magnetic particles give equal-signed signal contributions and the total signal magnitude scales with the concentration of particles in the bulk. In fact, the signal contribution from the surface is minimized, which facilitates the interpretation of the measurement signal in terms of bulk concentration. The bigger the distance between the beads and the sensor element becomes, the further the sensor ‘sees’ but the weaker the signal gets. Therefore, the distance between the sensor element 34 and the beads 31 may not be too big nor may it be too little. Preferably, the distance is between 1 μm and 300 μm. It has furthermore to be noted that it may be advantageous to exclude also reagents and/or biological material from the exclusion zone, for cost-effectiveness, to avoid loss of targets, etc.

In a first embodiment according to the present invention, which is illustrated in FIG. 4, a first magnetic sensor device (40) according to the invention is described. The magnetic sensor device 40, according to this embodiment of the invention, comprises at least one magnetic or electric field generating means 41 and at least one magnetic sensor element 42. In the description of the present embodiment, the magnetic field generating means 41 is an on-chip magnetic field generating means such as a current wire. Hence, in this embodiment, the magnetic field generating means 41 will further be referred to as current wire 41. However, this is not limiting to the invention. In general the magnetic field generating means 41 may for example be an external magnetic field generating means or an on-chip magnetic field generating means and may for example be a current wire, an electromagnet, a permanent magnet or external coils. The invention may also be applied in case an electric field generating means is used. The magnetic sensor element 42 may for example be a thin-film magnetic sensor, for example a magneto-resistive sensor, a Hall sensor, a giant-magneto-impedance sensor, etc. In case of a magneto-resistive sensor, the sensor element 42 may for example be a GMR, a TMR or a AMR sensor element and may, for example, have a long and narrow strip geometry. In the description of the present embodiment, the magnetic sensor device 40 will be described as comprising a GMR sensor element. Therefore, in the further description, the magnetic sensor element 42 will be referred to as GMR sensor element 42. This is, however, not limiting to the invention, as it is understood by a person skilled in the art that the principles explained in the description for a GMR sensor element 42 also may be applied to sensors comprising other magneto-resistive sensor elements or to other thin-film magnetic sensor types.

The sensor device 40 according to the first embodiment thus for example comprises a current wire 41 as the magnetic field generating means and a GMR sensor element 42. The current wire 41 may, in this example given, have a thickness (in the z-direction) of 0.35 μm and a width (in the x-direction) of 3 μm. In this embodiment, the width (in the x-direction) of the GMR sensor element 42 is 3 μm. The distance (in the x-direction) between the current wire 41 and the GMR sensor element 42 is, in the example given, 3 μm, but may have any other suitable size as the sensor element to current wire distance will change the depth response. By changing the distance between the current wire 41 and the sensor element 42, the required depth sensitivity may be achieved for different particular applications.

The above-described part of the sensor device 40, comprising the current wire 41 and the GMR sensor element 42, will in the further description be referred to as the sensor chip 43.

The magnetic sensor device 40 furthermore comprises an exclusion zone 44 for particles to prevent them from approaching the sensor proper too closely. In this embodiment, the exclusion zone 44 may comprise two parts, i.e. (i) a ‘cover layer’ 44a between the magnetically sensitive layer of the sensor element 42, which in the present invention may be at z=40 nm, and the surface 45 of the sensor chip 43 and (ii) a spacer 44b on top of the surface 45 of the sensor chip 43. Hence, the exclusion zone 44 is located above the GMR sensor element 42.

The spacer 44b is preferably integral with the sensor chip 43, and is formed as a layer of the sensor chip 43 or as a separate spacer layer 44b which is fixed to the surface 45 of the sensor chip, e.g. laminated or glued. Alternatively, the spacer 44b may be deposited by any suitable conventional deposition technique known by a person skilled in the art, such as e.g. printing, sputtering, vapor deposition, dip coating, or spin coating. The exclusion zone 44 may have a thickness between 1 and 300 μm, preferably between 1 and 200 μm and more preferably between 1 and 100 μm. The z-dimension (indicated by arrow 47 in FIG. 4) is measured from the bottom of the sensor element 42. The exclusion zone 44 is also defined from the bottom of the sensor element 42. Thus, strictly spoken, the thickness of the exclusion zone 44 equals the sum of the thickness of the spacer 44b, the thickness of the ‘cover layer’ 44a and the thickness of the sensor element 42 above its sensitive layer, which typically may be 10 nm. However, for the ease of explaining, in the further description, the exclusion zone 44 will be referred to as comprising the ‘cover layer’ 44a and the spacer 44b. It has, however, to be kept in mind that the thickness of the sensor element 42 above its sensitive layer also is included when the thickness of the exclusion zone 44 is discussed.

The spacer 44b avoids the presence of magnetic particles or beads 46 in the direct vicinity of the surface 45 of the sensor chip 43. In that way, the presence of beads 46 in the vicinity of the top surface of the GMR sensor element 42 is also avoided. In other embodiments, the presence of beads 46 in the vicinity of the top surface of the GMR sensor element 42 may also be avoided by increasing the thickness of the ‘cover layer’ 44a between the sensor element 42 and the surface 45 of the sensor chip 43. The spacer 44b preferably may be formed out of a non-magnetic material, and may, for example, comprise plastic material. The spacer 44b may also comprise a foil material which may mechanically be bound to the surface 45 of the sensor chip 43. Also, the foil material may be pressed against the surface 45 of the sensor chip 43 or there may be a gap between the material and the sensor surface 45.

For the magnetic sensor device 40, illustrated in FIG. 4, the GMR voltage U_{GMR,bulk}=−1.61 μV, which brings the detection limit in this approach to d_{limit,bulk}=1.4 10⁻³ beads/μm³, which is a factor 4.6 lower than in the sensor device as described with respect to FIG. 2.

An advantage of the magnetic sensor device 40 according to the invention, is that it is very easy to integrate the sensor device 40 in product lines of commercial providers of lateral flow biochips, as existing lateral-flow products already have a plastic foil laminated to the nitro-cellulose strip for mechanical purposes, e.g. as a mechanical support.

In a second embodiment of the present invention, another possible magnetic sensor device 40 is described, which is illustrated in FIG. 5. The sensor device 40 in this embodiment has the same configuration as the sensor device 40 described in the first embodiment but now the sensor chip 43 may comprise as a magnetic field generating means a current wire 41 with a width of 50 μm, which is about a factor 17 wider than the current wire 41 in the first embodiment. The GMR sensor element 42 may still have a width of 3 μm. The distance between the current wire 41 and the GMR sensor element 42 may also still be 3 μm. The sensor device 40 according to the second embodiment furthermore comprises an exclusion zone 44, which in this second embodiment may, for example, comprise a ‘cover layer’ 44a and a spacer 44b. In this embodiment, the spacer 44b may have a thickness of 5 μm and is positioned on top of surface 45 the sensor chip 43.

The exclusion zone 44 avoids the presence of beads or magnetic particles 46 in the direct vicinity of the sensitive layer of the GMR sensor element 42. The exclusion zone 44 in this embodiment may be thicker than with respect to the first embodiment, however may still lie within the range 1 to 300 μm, preferably between 1 and 200 μm and most preferably between 1 and 100 μm. The thicker spacer 44b increases the distance between the sheet of beads 46 and the sensor element 42 and thus further increase the focal depth. The distance between the sheet beads 46 and the sensor element 42 is indicated by arrow 47 in FIGS. 4 and 5.

FIG. 6 illustrates the increased depth-probing range achievable with the magnetic sensor device 40 according to the second embodiment. The figure shows the GMR voltage at 1 bead/μm³ volume density as a function of the z-position of a sheet of beads 46, which is defined as the distance between the beads 46 and the sensor element 42. In FIG. 5, the z-position of the sheet of beads 46 is indicated by arrow 47. Assuming the same parameter values as indicated before, the GMR voltage U_{GMR,bulk}=−0.74 μV which brings the volume detection limit in this approach, calculated with the parameters as given above, to d_{limitbulk}=2.9 10⁻³ beads/μm³. In this embodiment, the current density is much lower than in the first embodiment, because the same current is now sent through a wider current wire 41. Due to the 50 μm wide current wires 41, the maximum current which is limited by electro migration, can be increased to at least 1.75A. Hence, the detection limit will improve a factor 175 compared to the above estimation, i.e. the detection limit becomes 1.65 10⁻⁵ beads/μm³.

According to a third embodiment of the invention, the sensor chip 43 may comprise a first and a second magnetic field generating means, e.g. a first and a second conductor 41a, 41b and a MR sensor element such as a GMR sensor element 42, wherein each conductor 41a, 41b may be positioned adjacent an opposite side of the magneto-resistive sensor element 42 at a same position with respect to the plane of the magneto-resistive sensor element 42 (FIG. 7). Both current wires 41a,b may have a width of 50 μm and the distance between each current wire 41a,b and the magneto-resistive sensor element 42 may, in this embodiment, for example be 3 μm. In this embodiment, the exclusion zone 44 comprises a ‘cover layer’ 44a and a spacer 44b located on top of the surface of the sensor element 42 and is in this embodiment typically also in the range 1 to 300 μm, e.g. 7 μm. Arrow 47 indicates the distance between the beads or magnetic particles 46 and bottom of the sensor element 42.

As already described, if the sensor device 40 is positioned in the xy plane, the GMR sensor element 42 detects essentially a component of the magnetic field in a certain direction e.g. the x-component of a magnetic field, i.e. the x direction is the sensitive direction of the sensor element 42. According to this embodiment, the magnetic field is thus applied to the magnetic particles or beads 46 by means of a current flowing in the integrated current wires 41a,b. Preferably, the current wires 41a,b may be positioned in such a way that they generate magnetic fields in the volume where magnetic particles or beads 46 are present. By applying, for example, currents I_w₁ and I_w₂ in the positive y-direction to the current wires 41a resp. 41b, as illustrated in FIG. 7, a resultant magnetic field essentially in the positive x-direction is generated. By choosing the currents I_w₁ and I_w₂ in that way, information about the number of magnetic particles or beads 46 (the sum-signal) can be achieved. FIG. 8 illustrates the GMR signal (sum signal) as a function of the x-position of the beads 46, which are at 50,6 μm from the surface 45 (in the z-direction) of the sensor chip 43, with I_w₁=I_w₂=10 mA. The sum signal is a measure for the total number of magnetic particles 46, and their magnetization (diameter, permeability).

By inverting one of the current directions in the wires 41a, 41b, the magnetic field becomes asymmetrical, with opposite x-fields to the right and left of the sensor device 40. By choosing the currents I_w₁ and I_w₂ that way, information can be achieved about the position and inhomogeneity of the magnetic particles or beads 46. It has to be noted that in that case, for a uniform surface density or volume density, the GMR voltage equals to zero.

In FIG. 9 the depth probing range of the sensor device 40 of FIG. 7 is depicted. The figure shows the GMR voltage at 1 bead /μm³ volume density as a function of the z-position which is indicated by arrow 47. The GMR voltage equals to U_{GMR,bulk}=−0.27 μV. This brings the volume detection limit in this approach to d_{limit, bulk}=8.10⁻³ beads/μm³. Thus, by applying two current wires 41a, 41b as the magnetic field generating means, the depth probing range may be further extended with respect to the second embodiment. The signal contribution as a function of z-bead decreases less rapidly in FIG. 9 compared with FIG. 6. The reason for this is that a magnetic field is generated in a much larger volume in case of the sensor device 40 in FIG. 7, at the price of using two times the current. Furthermore, the depth probing sensitivity in this embodiment is more constant compared to that in the second embodiment, which is advantageous.

In a further embodiment of the invention, yet another sensor configuration is described. The magnetic sensor device 40 according to this invention may comprise a plurality of alternating magnetic field generating means, such as current wires 41a-f, and MR sensor elements, such as GMR sensor elements 42a-e (see FIG. 10). In the present embodiment, the current wires 41a-f may all have the same shape and sizes, and may have a width of 3 μm. However, in other embodiments, current wires 41a-f may have different shapes and sizes. The distance between each current wire 41a-f and the subsequent GMR sensor element 42a-e may for example be 3 μm. However, in other embodiments, the distance between each current wire 41a-f and the subsequent GMR sensor element 42a-e does not have to be the same.

By applying a plurality of current wires 41a-f and GMR sensor elements 42a-e, the depth probing range of the sensor device 40 may be further increased with respect to the previous embodiments. An exclusion zone 44 is located on top of the sensor element 42, which exclusion zone comprises a ‘cover layer’ 44a and a spacer 44b. The thickness of the exclusion zone 44 may be between 1 and 300 μm, preferably between 1 and 200 μm and more preferably between 1 and 100 μm. Ideally, the exclusion zone 44 may be determined such that all magnetic particles or beads 46 contribute to the signal with the same sign.

For this embodiment and all previous embodiments, it has to be noted that the currents and the GMR signals may be operated time-multiplexed, as well as in parallel.

In a fifth embodiment according to this invention, the exclusion zone 44 maybe in the form of a ‘cover layer’ 44a and a spacer 44b with a thickness within the range 1 to 300 μm, e.g. 10 μm. In this embodiment, the spacer 44b is not provided directly on the top surface 45 of the sensor chip 43, but may comprise at least one coupling means 48 for galvanic, magnetic, electrical, optical and/or RF coupling to external connections (see FIG. 11). For example, a conductive material may be deposited on the spacer 44b to form an inductor in case of magnetic coupling, to form an antenna in case of RF coupling and to form a conductive surface (one plate of a capacitor) in case of capacitive coupling. Furthermore, the coupling means 48 may comprise photo sensitive (photo diode) or photo emitting (LED, polyLED) or photo active (e.g. LCD, electrochromic) materials in case of optical coupling. Furthermore, combinations like optical/RF coupling means may be possible.

The coupling means 48 may be connected to the surface 45 of the sensor chip 43 via, for example, a flip-chip technique, e.g. by means of galvanic connections 49. The sensor chip 43 may be a sensor chip 43 according to those described in the previous embodiments. In FIG. 11, the detection volume of the sensor device 40 is indicated by reference number 50.

The coupling means 48 may be used to exchange electrical signals (data and power) between the magneto-resistive sensor device 40 and a reader system (not shown in the figure). The required electronics may be included in the sensor chip 43. The coupling means 48 and the required electronics on the sensor chip 43 and in the read-out station (not shown) are well known to a person skilled in the art and they can transfer power and bidirectional data between the sensor device 40 and the reader station (not shown). Examples may be the MIFARE transmission standard for wireless tags (inductively, 13.56 MHz) and the Hitachi Meu chip (RF, 2.45 GHz). It has to be noted that, according to the invention, coupling means 48 may be integrated on the sensor chip 43 itself. Examples may be optical or RF coupling means. The required electronics may, however, instead of being provided on the sensor chip 43, also be provided on a separate chip, i.e. the electronics chip 51, as illustrated in FIG. 12. The electronics chip 51 may be connected to a surface 52 of the sensor chip 43 opposite to the surface 45 of the sensor chip 43 on which the coupling means 48 and the spacer 44b is provided. This may be performed by, for example, a flip chip technology.

In a sixth embodiment of the invention, a lateral-flow biosensor system 60 is provided (FIG. 13). In this figure, an example of a lateral-flow assay is presented. The system 60 comprises a sample fluid supply 61, which may comprise a test fluid comprising target molecules that have to be analyzed, a porous medium 62 like for example nitrocellulose, which comprises a reagent or a capture layer, such as for example antibodies, antibodies provided with labels or magnetic particles 46, and a sensor device 40 according to the invention. The test fluid moves, driven by capillary forces, through the porous medium 62. The reagent dissolves in the test fluid and subsequently binds the target molecules, which are then captured in the sensitivity region, forming immobilized beads 63. The bound complexes, i.e. the target molecules bound to the first labelled antibodies, are captured on the solid surface by a sandwich structure, i.e. a surface-antibody-target-antibody-label structure. The high-surface-area material, i.e. the porous medium 62, and the sensor device 40 may be closely integrated, both part of a single-use disposable product, or these may be separable for re-use. The required electronics may be integrated on the sensor chip 43, as is the case in the system 60 illustrated in FIG. 13. However, the required electronics may also be on a separate chip, as has been described with respect to FIG. 12. The construction of the lateral-flow biosensor system 60, as illustrated in FIG. 13, gives a very convenient micro fluidics design with high-surface-area binding region. The sensor device 40 with large depth sensitivity enables this architecture.

FIG. 14 shows a top view of a possible configuration of a single sensor module 70 which can be used in the lateral-flow biosensor system 60. The sensor module 70 may comprise a first and a second current wire 41a resp. 41b, a GMR sensor element 42 positioned in between the current wires 41a, 41b, and a porous medium 62 comprising a reagent extending over both current wires 41a,b and the GMR sensor element 42, a spacer (not represented in FIG. 14) being present between the porous medium 62 on the one hand and the current wires 41a, 41b and GMR sensor element 42 on the other hand.

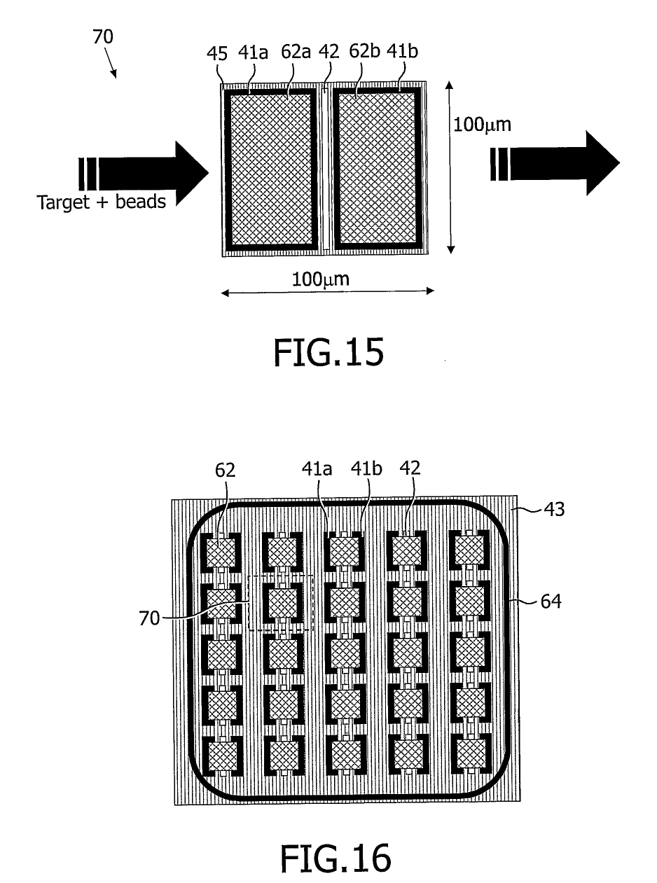

Another possible configuration of a single sensor module 70 which may be used in the lateral-flow biosensor system 60, is illustrated in FIG. 15. This configuration differs from the one in FIG. 14 in that on top of the first current wire 41a a first porous medium 62a comprising a first reagent is provided, and on top of the second current wire 41b a second porous medium 62b comprising a capture layer is provided, there being an exclusion zone 44 (not represented in FIG. 15) between the current wires 41a, 41b on the one hand and the porous media 62a, 62b on the other hand. In between both current wires 41a, 41b a GMR sensor element 42 is positioned which is not covered by either the first or the second porous medium 62a, 62b. It is to be understood that the invention is not limited to two porous media each comprising a different capture layer. This configuration offers the possibility to analyze different types of target molecules in a sample fluid at the same time.

A plurality of sensor modules 70 according to either FIG. 14 or FIG. 15 may be located on a single sensor chip 43, as illustrated in FIG. 16. The sensor chip 43 may comprise the sensor modules 70 as well as the required electronics (not shown) for amplification, current generation, demodulation, etc. Also an on-chip antenna 64 may be incorporated on the sensor chip 43, in order to communicate data and collect power from a reader station. It will be obvious that multiple mutually connected chips are also possible.

In a further embodiment of the present invention, the external magnetic field may be applied by external magnetic field generating means 65 instead of on-chip magnetic field generating means 41 in the previous embodiments. In this embodiment, the external magnetic field generating means 65 may comprise two external coils 65a and 65b (see FIG. 17 (cross sectional view) and FIG. 18 (top view)). The use of two external coils 65a, 65b as the magnetic field generating means is only by means of illustration and thus is not limiting the invention. The sensor chip 43 may be located in between the two external coils 65a, 65b, and may, in contrast with the previous embodiment, now only comprise at least one magnetic sensor element 42, such as for example a magneto-resistive sensor element (e.g. a GMR, TMR or AMR sensor element). On a top surface of the sensor chip 43, a spacer 44b is provided. On top of the exclusion zone 44 and thus on top of the spacer 44b, a porous medium 62, such as for example nitrocellulose (paper), comprising e.g. antibodies is provided. The magnetic excitation field is applied via the external coils 65a,b. A cross sectional, schematic illustration of the sensor configuration according to this seventh embodiment is shown in FIG. 17. The geometry is chosen such that:

the in-plane magnetization in the sensitive layer 66 of the GMR sensor element 42 by the coil fields is minimized, so as to minimize signals in the sensor device 40 due to the coil fields, and

the magnetic field in the bulk of the high-surface-area binding region is mainly horizontally oriented.

An advantage of the sensor device 40 according to the present invention is that it allows sensitive magnetic detection in a high-surface-area biosensor, for measurements with high depth sensitivity. The sensor device 40 according to this invention shows a sensitivity in the order of 10⁻³ beads per μm³ for moderate currents, short averaging time (less than 1 second), and sub-micrometer beads. Furthermore, the sensor device 40 is accurate, easy to use and inexpensive, while still enabling multiplexing or multi-target detection. For a further increase of signal-to-noise ratio, magnetic actuation can be used to:

increase the speed of the assay,

apply magnetic stringency, and

apply label-rotation-spectroscopy.

The sensor device 40 according to the invention may be applied with magnetic fields applied via on-chip current wires 41 as well as using magnetic field generators 65a, 65b outside the chip. Furthermore, the magnetic sensor device 40 according to this invention, may be integrated with immuno- and capillary-chromatography test strips. Therethrough, it may improve products in existing markets, which may provide an attractive market entry for the magnetic sensing technology.

Furthermore, by changing the geometry of the magnetic sensor device 40, i.e. e.g. GMR width versus current wire width <1 or in other words by choosing the current wires 41 such that the width of the current wires 41 is higher than the width of the GMR sensor element 42, a larger depth-probing range is achieved with the sensor device 40 according to the present invention. The GMR width versus current wire width is preferably smaller than 1, more preferably smaller than 0.5. The ratio should not be too small in order to allow for a sensitive detection of magnetic field by the GMR sensor element 42. This GMR width versus current wire width may be such as to optimize the depth sensitivity range. Ideally, the ratio is such that a uniform sensitivity is achieved in a certain depth range.

The sensor device 40 according to the present invention uses integrated wires 41 for magnetic excitation at high frequencies. The integrated wires 41 generate predominantly in-plane magnetic fields. This is in contrast with the out-of-plane field and the low measurement frequencies used in the prior art. Furthermore, in the sensor device 40 according to the invention, particle-to-sensor element distances preferably between 1 μm and 300 μm, more preferably between 1 and 200 μm and still more preferably between 1 and 100 μm are applied by the provision of an exclusion zone 44. The combination of the above mentioned factors leads to a high detection sensitivity, even for relatively large particle-to-sensor distances.

When the volume of the region where a magnetic field is generated is well matched to the region where magnetic particles or beads 46 are present, then the system may have a minimum inductance, which is useful for low-power operation at high frequencies and at relatively high magnetic fields.

The method of the invention may be applied in a variety of device architectures and diagnostic applications. The device may for example be a single sensor or an array of biosensors or a so-called bio-chip. The sensor device 40 can be part of a disposable device or may be part of a re-usable reader. For example, the sensor device 40 can be part of or used with a cartridge or a lab-in-a-device, containing fluid channels, reservoirs, reagents, etc. Also the sensor device 40 may be part of or used with a disposable pipette tip or an affinity column. The sensor device 40 may also be applied in or to a well or multiple wells, e.g. a well-plate or a microtiter plate.

Furthermore, the sensor device 40 may be used for a molecular assay, but also for the detection of (or for the detection of components of or processes in) micro-organisms, cells, cell cultures, living or dead material, cell fragments, tissue, etc. Several types of assays can be used, e.g. binding assay, unbinding assay, sandwich assay, competitive assay, displacement assay, comparative hybridisation assay, cluster assay, magnetic rotation assay, diffusion assay, etc.

It is to be understood that although preferred embodiments, specific constructions and configurations, as well as materials, have been discussed herein for sensor devices 40 according to the present invention, various changes or modifications in form and detail may be made without departing from the scope and spirit of this invention. For example, the invention has been described by means of providing a spacer 44b above the GMR sensor element 42, which forms an exclusion zone 44 for excluding beads or magnetic particles 46 from the sensor surface 45. In alternative embodiments according to the invention, part of the exclusion zone 44 may be a gap with a fluid medium (gas, liquid, vacuum) situated between the sensor device 40 and the magnetic particles 46. In alternative embodiments according to the invention, the exclusion zone 44 may also be provided by burying the magnetic sensor element 42 deeper in the sensor substrate. Furthermore, in another embodiment according to the invention, the functionality of an exclusion zone 44 may be implemented by having a zone where magnetic particles or beads 46 do not stick, where magnetic particles or beads 46 can be removed, or where magnetic particles or beads 46 cannot enter due to mechanical forces. In one example, the exclusion of magnetic particles or beads 46 from the exclusion zone 44 may be implemented or partly implemented by applying mechanical forces to the magnetic particles or beads 46, hence avoiding or removing the presence of magnetic particles or beads 46 in the vicinity of the sensor surface 45 during the measurement. Mechanical forces may have a magnetic or electrical origin, e.g. due to fields or field gradients. Alternatively, the forces may be generated by fluid flow, a pressure gradient, capillary forces, shear forces, etc. In another example, the magnetic particles or beads 46 do not stick to the sensor surface due to the absence of a capture or binding layer. The binding-free area or volume near the sensor then realizes an exclusion zone 44. The magnetic particles 46 may be removed from the exclusion zone 44 by fluid flow or by other forces.

1. A sensor device (40) for detection of the presence of at least one magnetic particle (46) comprising:
at least one magnetic or electric field generating means (41), and
at least one magnetic sensor element (42) having a sensitive layer, and
wherein said sensor device (40) is provided with an exclusion zone (44) between the sensitive layer of the at least one magnetic sensor element (42) and the at least one magnetic particle (46), for excluding the presence of said at least one magnetic particle (46) in the vicinity of said at least one magnetic sensor element (42), the exclusion zone (44) having a thickness of between 1 and 300 μm.

2. A sensor device (40) according to claim 1, the sensor device (40) comprising a sensor surface (45), wherein said exclusion zone (44) comprises a spacer (44b) provided on top of said sensor surface (45).

3. A sensor device (40) according to claim 1, the sensor device (40) comprising one magnetic or electric field generating means (41) and one magnetic sensor element (42) positioned adjacent to each other.

4. A sensor device (40) according to claim 3, the magnetic or electric field generating means (41) having a first width and the magnetic sensor element (42) having a second width, wherein the first and second width are such that the second width to first width ratio is smaller than 1.

5. A sensor device (40) according to claim 1, wherein a magnetic or electric field generator means (41) is positioned at each side of the magnetic sensor element (42).

6. A sensor device (40) according to claim 1, wherein a plurality of magnetic or electric field generator means (41) and magnetic sensor elements (42) are positioned alternately adjacent to each other.

7. A sensor device (40) according to claim 2, the sensor device (40) furthermore comprising at least one coupling means (48) in between said spacer (44b) and the sensor surface (45) of the sensor device (40).

8. A sensor device (40) according to claim 7, wherein said coupling means (48) is connected to the sensor surface (45) via a flip-chip technique.

9. A sensor device (40) according to claim 1, the sensor device (40) furthermore comprising:
at least one porous medium (62), each porous medium (62) comprising a reagent or a capture surface, said at least one porous medium (62) being integrated with said exclusion zone (44) of the sensor device (40), and
a sample fluid supply (61) for supplying the sample fluid to said at least one porous medium (62).

10. A sensor device (40) according to claim 7, the sensor device (40) furthermore comprising:
at least one porous medium (62), each porous medium (62) comprising a reagent or capture layer, said at least one porous medium (62) being integrated with said exclusion zone (44) of the sensor device (40), and
a sample fluid supply (61) for supplying the sample fluid to said porous medium (62).

11. A sensor device (40) according to claim 9, wherein the sensor device (40) comprises a first porous medium (62a) comprising a first reagent or capture layer and a second porous medium (62b) comprising a second reagent or capture layer, said first and said second reagent or capture layer being different from each other.

12. A sensor device (40) according to claim 10, wherein the sensor device (40) comprises a first porous medium (62a) comprising a first reagent or capture layer and a second porous medium (62b) comprising a second reagent or capture layer, said first and said second reagent or capture layer being different from each other.

13. A sensor device (40) according to claim 1, wherein the at least one magnetic field generating means (41) is an on-chip magnetic field generating means.

14. A sensor device (40) according to claim 13, wherein the on-chip magnetic field generating means (41) is a current wire.

15. A sensor device (40) according to claim 1, wherein the at least one magnetic field generating means (41) is an external coil.

16. A sensor device (40) according to claim 1, wherein the magnetic sensor element (42) is a magneto-resistive sensor element.

17. An array of sensor devices (40), comprising a plurality of sensor devices (40) according to claim 1.

18. An array of sensor devices (40), comprising a plurality of sensor devices (40) according to claim 9.

19. An array of sensor devices (40), comprising a plurality of sensor devices (40) according to claim 10.

20. The use of the sensor device (40) according to claim 1 in chemical or biological molecular diagnostics or in biological sample analysis.

21. The use of the sensor device (40) according to claim 9 in chemical or biological molecular diagnostics or in biological sample analysis.

22. The use of the sensor device (40) according to claim 10 in chemical or biological molecular diagnostics or in biological sample analysis.

23. A method for detection of the presence of at least one magnetic particle (46), the method comprising:
providing a sample fluid with at least one magnetic particle (46),
thereafter providing a sensor device (40) in contact with said sample fluid, said sensor device (40) comprising
at least one magnetic or electric field generating means (41), and
at least one magnetic sensor element (42), said at least one magnetic sensor element (42) having a top surface,
applying an electric or magnetic field,
and wherein the presence of at least one magnetic particle (46) in the direct vicinity of the at least one magnetic sensor element (42) is avoided by providing said sensor device (40) with an exclusion zone (44) having a thickness of between 1 and 300 μm.

24. A method according to claim 23, said sensor device (40) having a sensor surface (45), wherein providing said sensor device (40) with an exclusion zone (44) is performed by providing a spacer (44b) on top of said sensor surface (45).
